(19) United States
(12) Patent Application Publication
(10) Pub. No.: US 2013/0346608 A1
(43) Pub. Date: Dec. 26, 2013

(54) Setting Method for Account ID Access Permissions and Controller

(71) Applicant: Zeon Corporation, Taipei (TW)

(72) Inventor: Tien Chun Tung, Taipei City (TW)

(21) Appl. No.: 13/922,751

(22) Filed: Jun. 20, 2013

(30) Foreign Application Priority Data
Jun. 21, 2012 (CN) 201210207975.2

(51) Int. Cl. H04L 12/70

(52) U.S. Cl. CPC H04L 47/70
USPC 709/225

(57) ABSTRACT

A setting method for Account ID access permissions and a controller perform connection of the controller and a network device through a communication platform, after the controller connects with the network device to be set with Account ID access permissions through the communication platform, a setting function of Account access permissions may be opened, and a setting result is entered, and the setting result is sent to the network device connected therewith; the network device will store the setting result, and open its access service or access constraint according to the setting result.

### CROSS-REFERENCE TO RELATED APPLICATIONS

This application claims the priority of China Patent Application No. 201210207975.2 filed on Jun. 21, 2012, in the State Intellectual Property Office of the P.R.C., the disclosure of which is incorporated herein by reference.

### BACKGROUND OF THE INVENTION

1. Field of the Invention

The invention relates to a setting technology for access permission of Account ID, particularly to a setting method for setting an access authority that can allow the access to Account ID of a network device, and a controller.

2. Descriptions of the Related Art

Conventionally, when setting or controlling a network device without input/output (I/O) interface, for example, router, network printer, network camera, an user has to use a controller with I/O interface, such as computer, smart phone, to enter a preset IP address of the device to be set or controlled on the controller. The user has to enter much connection information such as IP address of the network device, login IP address, login Account ID, login password, sequentially on the I/O interface of the controller. The network device may connect to a server to be logged in to implement desired network service only after long time input. If the network device is in a local area network behind a router, the user may further has to set the router for the router to allow network connection between the network device and the controller. The user must have basic concept about network to complete the aforementioned setting. As for general users, the above networking setting is pretty complex and difficult.

For example, a building management firm has to configure multiple network cameras in doors, elevators, ladder spaces of partial important floors etc. of a community building. Further, network cameras issue recorded contents to a specific multimedia storage device for the multimedia storage device to access the contents recorded by and issued from all network cameras. However, before using the multimedia storage device to access the contents recorded by the network cameras, for the purpose of making all network cameras to connect to internet, and making the multimedia storage device to accept a service request to provide corresponding service, it is necessary to perform aforementioned complex internet connection and the setting for logging in to a communication platform. It is pretty inconvenient. Further, it is necessary to apply respective login Account IDs/passwords for different network cameras and thus results in inconvenient management.

Besides, after the above network devices login successfully to a server with a registered login Account ID, an owner or an administrator with administration authority of the network device may sometimes want to share an access permission to relatives and friends. However, it is what those skilled in the art intend to figure out about how those relatives and friends can recognize that they have already authority to access the network device, and how the aforementioned owner and administrator with administration authority of the network can set access permission for the network device quickly and conveniently.

### SUMMARY OF THE INVENTION

In view of problems of conventional technologies, the purpose of the invention is to provide a setting method and a controller for access permissions of Account ID such that an owner or an administrator with administration authority of a network device can set access permissions for the network device quickly and conveniently.

According to another purpose of the invention, a setting method and a controller for access permissions of Account ID are provided for clients who are set to have the access permissions of a network device to allow the network device to connect to network quickly and easily.

For the above purpose, the invention provides a setting method for Account ID access permissions. The controller and the network device are connected through a communication platform, and the communication platform records, for the controller and the network device that login successfully, control identification information and network device identification information, respectively. The control identification information includes a login Account ID used to log in to the communication platform and an APP ID and an IP connection method of a control application installed and executed on the controller. The network device identification information includes a login Account ID used to log in to the communication platform, an APP ID and an IP connection method of a function application installed and executed on the network device. The setting method for the Account ID access permissions includes the following procedure: after the control application of the controller connects with the network device to be set with Account ID access permissions through the communication platform, open a setting function for Account ID authority in the control application and enter the setting result, and send the setting result to the network device connected therewith; and the function application of the network device stores the setting result, and opens an access service or an access constraint of the network device according to the setting result.

The login Account ID of the controller is an Account ID having an administrator identity of the network device, and the setting function of the Account ID access permissions opened by the control application of the controller includes: whether or not to allow setting for Account ID allowing access to the network device, or whether or not to allow using setting of the network device in a local area network.

In the above setting method for Account ID access permissions, the controller or the network device that is set searches and acquires controller identification information on the communication platform, to issue a notice to the controller that uses the Account ID, which allows access to the network device, to log in to the communication platform according to the IP connection method in the controller identification information that is found out, wherein, the controller identification information includes at least the login Account ID, which allows access to the network device, and the APP ID corresponding to the login Account ID is an APP ID corresponding to an application used to interact with the function application of the network device. Moreover, the controller that receives the notice utilizes the Account ID, which allows access to the network device, and utilizes the controller application installed thereon to connect directly with the network device that is allowed to be accessed.

Besides, the control application of the controller may further provides a setting function of registrant identity confirmation for the Account ID having a mail box host name, so that as the login Account ID used to log in to the communication platform is a mail Account ID of an email address, the mail box host name of the mail Account ID identifies whether or not to allow the mail Account ID to access the network device.

The invention further provide a controller, which connects with at least one network device that is configured as a service unit of the communication platform successfully through the communication platform, for the controller to perform interaction process with the at least one network device. The network device has a function application module. The communication platform stores, for the network device configured successfully, device identification information, including the login Account ID thereof, the APP ID of the function application module and the IP connection method thereof. The controller includes: a communication module, used for connection with the network device and/or communication platform; and a control application module, used to output the login Account ID/password used to log in to the communication platform through the communication platform, and perform the setting function for the Account ID access permissions after connection with the network device, and for the function application module of the network device to store the setting result, to open the access service or access constraint of the network device according to the setting result.

In the above controller, the control application module may further perform recording for the login Account ID used by the network device that has performed control process, and show a list of recorded login Account IDs of the network device for selection, the selected login Account ID will have corresponding barcode pattern generated. Further, the control application module may further have a function of scanning the barcode pattern, to interpret the login Account ID of the network device represented by the barcode pattern, and search the network device identification information in compliance with the login Account ID on the communication platform, to thereby acquire the IP connection method of the network device by the found out network device identification information and perform connection.

The barcode pattern generated by the above controller is displayed on a local screen, stored in a local storage unit, printed out, uploaded to cloud, or sent to an external storage unit, for another controller to access or scan directly, and thereby interpret the login Account ID of the network device corresponding to the barcode pattern, such that the user desiring for connection may save inconvenience to enter a series of messages for login.

In conclusion, for an administrator or owner of a network device, the setting method of Account ID access permissions and the controller according to the invention may perform setting of access permissions for the network device quickly and conveniently. Also, the setting of access permissions is more flexible by the above setting of “whether to allow the use of the network device in a local area network” and the setting of “performing registrant identity confirmation for the Account ID having a mail box host name”. Besides, after setting the Account ID of access permissions, a notice may be issued to a controller, which uses the Account ID allowing access to log in to the communication platform, according to the IP connection method corresponding to the Account ID allowing access, and the controller, which receives the notice, may also utilizes the control application installed thereon to perform connection with the network device using the Account ID allowing access. Therefore, the convenience of connection of a user with a network device is improved significantly. That is, there is no need to enter a series of connection messages manually for the network device to be connected. The above setting method of access permissions may simplify input procedure. Especially for those users unfamiliar with input operation, the invention may provide convenient connection operation to, thereby, overcome the resistance of people for connection operation of network devices.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view of a system architecture of a setting method for access permissions of Account ID according to the invention;

FIG. 2 is a process flow chart to show how a network device becomes a legal unit in a communication platform;

FIG. 3 is a flow chart of a setting method for access permissions of Account ID according to the invention;

FIG. 4 is a flow chart of a method for a first controller to make quick connection between a second controller and a network device with a barcode pattern with respect to above FIG. 3;

FIG. 5 is a block diagram showing a basic architecture including a controller, a communication platform and a network device that implement the methods shown in FIGS. 3 and 4.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

The invention provides a setting method for an access permissions of an Account ID for an owner or an administrator with an administration authority of a network device to set an access list for the network device through a controller, such that a communication platform that provides connection between the controller and the network device, or the network that is set may issue an access notice to a client with the access permissions according to the aforementioned access list for the client to perform connection with the network device quickly and conveniently after receiving the access notice through his/her own controller.

It is set forth in advance that, the communication, which provides connection service for the controller and the network device, serves or configures various units. To ease identification and management, the communication platform will record APP IDs of all legal units. The so called “APP ID” indicates application identifier (application ID). An application identifier is planned and specified by an administrator of a communication platform in advance for an application executed by a legal unit which logs in to and operates on the communication. Therefore, all legal applications recognize their own application identifiers and application identifiers of other applications to be communicated and operated mutually. For example, the APP ID of a network camera (that is, application identifier of the network camera) is specified as 400, while the APP ID of a controller, which is used to manage the network camera, is specified as 500. Different units, which login to the communication platform, may find out with each other by the login Account IDs and APP IDs of the units. For example, the network device a user desires to manage may be a specific network camera. The user logs in to the communication platform with the login Account ID “B” of the user by the controller (having APP ID 500), which is used to control the network camera, in advance. Next, the user enters a login Account ID “A” of the network camera to be controlled on the controller. An application, which runs on the controller, will search the unit with “login Account ID as A and APP ID as 400” through the communication platform to find out the network device, which logs in with login Account ID “A” and APP ID “400”, on the communication platform for the controller to acquire an IP connection method of the network camera and connect with the network camera on the communication platform, and to perform control for the network camera. From above, network devices with different functions are classified by different APP IDs (that is, application identifiers). Therefore, the communication platform will record login Account IDs and APP IDs of the network devices for each network device that logs in. In addition, the program content of the aforementioned application (APP ID as 500) of the controller has already preset that the objective to be searched by APP ID 500 is APP 400. Further, the program content of the application of the network camera may also declare in advance that it will only accept the service request asked by APP ID 500. Briefly, the APP ID of the application of each unit is specified by the administrator of the communication platform in advance. Thus, different or the same applications of different units may find out IP connection methods mutually with login Account IDs and APP IDs of login units through the communication platform to further connect with each and work together.

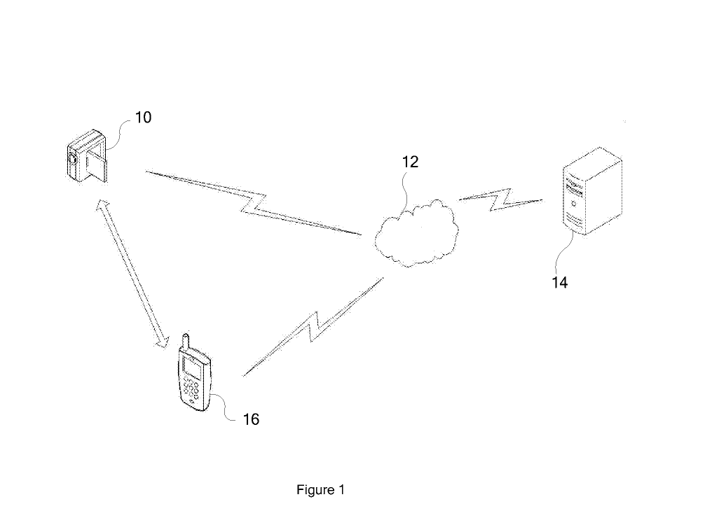

Next, refer to FIG. 1, which is a schematic view showing a system architecture of a setting method of an Account ID access permissions according to the invention. In the following example, the network camera 10 will be used as an example of the aforementioned network device for description, while the smart phone 16 will be used as an example of the aforementioned controller for description. However, the controller is not limited to the smart phone 16, but may be any electronic device provided with an output/input interface, for example, computer. Generally speaking, no setting message such as network parameters is set as the network camera 10 is delivered outside the plant. Therefore, in an usual situation, the network camera 10 cannot connect to the internet 12 or login to the communication platform 14, and it is necessary to perform settings, such as networking login, for the network camera 10 through the smart phone 16 provided with the output/input interface. To simplify complex setting procedure, the invention may create a wireless network link between the network camera 10 and the smart phone 16 with a wireless local area network function in advance. The wireless local area network function may be, for example, the Wi-Fi technology based on IEEE 802.11. In other words, the network camera 10 may be a Wi-Fi device, the smart phone 16 may find out the network camera 10 through the wireless function quickly, and set parameters, including internet link information and login Account ID/password, for the network camera 10.

From above, the communication platform 14 has to acquire the login Account ID of the network device and the APP ID thereof as a minimum for the network device, which logs in. The controller has to have a control application installed and executed thereon, while the network device has to have a function application installed and executed thereon. After both the controller and the network device login to the communication platform 14, they perform communication and operation by using the login Account ID and APP ID of the opposite side to find out the IP connection method of the opposite with each other on the communication platform through the control application and the function application installed thereon respectively. Refer to FIG. 1 as an example, after the network camera 10 connects with the smart phone 16 through the communication platform 14, the control application installed and executed on the smart phone 16 may perform notification setting, such as image event, for the network camera 10, while the function application installed and executed on the network camera 10 will store the setting result of the smart phone 16 to, subsequently, notify the smart phone 16 whenever a specific event is detected, for example, a suspicious image is recorded.

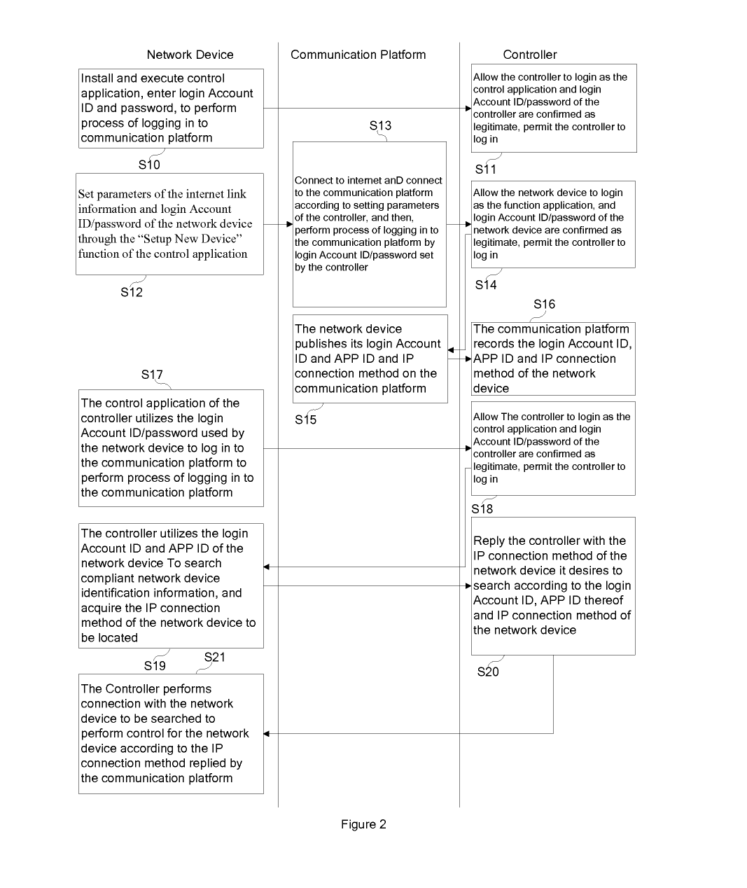

Refer to FIG. 2, which is a process flow chart for a network device to become a legal unit in the communication platform. To implement the purpose of quick connection with network device the invention intends to achieve, as it is necessary for the network device to log in successfully to the communication platform and become a unit in the communication platform, step S10 is performed at first. In step S10, an user performs a process of login to the communication platform by entering a login Account ID and password through a control application installed on the controller, followed by performing step S11.

In the step S11, the controller is allowed for login as the communication confirms that the control application and the login Account ID/password are legal, followed by performing step S12. It is noted that the communication platform records, for the controller or network device that logs in successfully, registration messages, including login Account ID and password thereof, for the communication platform to perform legality determination for the controller or network device that logs in.

In the step S12, the user selects a device setup function on the control application to set parameters, including internet link information and login Account ID/password, for the connected network device, followed by performing step S13. Here, the so called connection may be a wireless or wired method. For example, as the user selects the “Set New Device” function on the control application, the controller opens a wireless function and searches a wireless Service Set Identifier (SSID) of a network device named with a preset method. At the same time, the network device has also to open the wireless function and announce a message, which is capable of identifying the identity thereof, and wait for the connection with the controller. The message may be the SSID utilizing a hardware identifier as a preset naming method. The controller may search the network device by the message. However, it is not limited to wireless connection, wired connection is also available. Therefore, the connection method between both of them depends on architecture resource between the network device and the controller. In addition, there are many aforementioned SSID preset naming methods, which are in general composed of the APP ID and the hardware identifier of the network device (but not limited thereto). For example, in “gcam 2D3415A97B92”, gcam indicates the APP ID of the network device, while “2D3415A97B92” indicates the MAC address of a network card of the network device. The user may recognize the network camera (cam) once gcam is seen. The MAC address is generally printed on the housing of the network device, or printed in the attached user operation manual file for the user to confirm which network device is to be set if there are multiple network devices configured concurrently as the user has to set the network device.

In the step S13, the network device connects to the communication platform with the internet link information in the setting parameters after receiving the setting parameters sent from the controller, and then, performs the process of logging in to the communication platform with the login Account ID/password set by the controller, followed by performing step S14.

In the step S14, the communication platform confirms whether or not the function application and login Account ID/password of the network device are legal after receiving the login request from the network device and performs legality confirmation for the network device. The communication platform will allow the network device to log in only after legality confirmation, followed by performing step S15. In addition, To manage network devices, which login to the communication platform, effectively and securely, the communication platform may record multiple sets of legally authorized identifiers of network devices for the communication platform to verify whether or not the network device that logs in is authorized. The aforementioned identifiers may be hardware identifiers or product serial numbers, and any identifier capable of identifying the network device is applicable. In a general method, before commercial behavior that the network is delivered from plant or sold, the executor of the commercial behavior provides the identifier of the network device to the administrator of the communication platform for the administrator to record the identifier of the network device on the communication platform. Subsequently, the identifier may be used to check whether or not the network device is authorized legally, that is, to perform legality confirmation for the network device. Thus, it may prevent effectively unauthorized network devices from logging in to the communication platform arbitrarily. Also, the legality confirmation performed by the communication platform for the network device is not limited to the confirmation for the function application and the login Account ID/password of the network device, but includes the confirmation of whether or not the identifier of the aforementioned network device is authorized legally. The identifier of the network device is provided to the communication platform by the function application of the network device automatically to, thereby, control and manage effectively network devices which login to the communication platform for the prevention of unauthorized network devices to use illegally services provided by the communication platform.

In the step S15, after the net network device passes the legitimacy confirmation of the communication platform, the network device logs in to the communication platform successfully, and may publish the login Account ID and APP ID and IP connection method of the network device on the communication platform to further complete new device configuration task, followed by performing step S16.

In the step S16, the communication platform records the login Account ID, APP ID and IP connection method of the network device. That is, the communication platform has stored identification information (the identification information includes the login Account ID of the network device, the APP ID of the network device and the IP connection method thereof) for the network device which has been configured successfully and logged in, to provide for the controller, which logs in subsequently, to search the IP connection method of the network device to be found out according to the login Account ID/APP ID of the network device in the identification information, and connect with the network device to perform control setting task, as detailed below.

In step S17, a device administrator performs the process of logging in to the communication with the aforementioned login Account ID/password used by the network device to log in to the communication platform through the control application of the controller, followed by performing step S18. It is noted that if the controller, which desires to log in to the communication platform, uses the same login Account ID as the network device to log in to the communication platform, as the controller connects to a network device with the same login Account ID, the function application of the network device recognizes that the controller is the device administrator of the network device, and allow the controller to perform management operation. Also, it is noted particularly that, it is not the duty of the communication platform to determine whether or not the login Account ID used by the controller belongs to a device administrator identity, if the function application of the network device which has logged in to the communication platform discovers that the controller connected therewith uses the same login Account ID to log in, then the controller is allowed to perform management or control for the network device. Briefly, the job of the communication platform is only to provide connection between the controller and the network device that login, the operation method after login is implemented by the applications installed and executed on the controller and the network device. By the way, the function application of the network device determines whether the controller that logs in to the communication platform has a device administrator identity according to the equality of the login Account ID. That is, it is unnecessary to set a specific administrator Account ID for the network device, the aforementioned method may be used to define the administrator Account ID having the administrator identity for the network device.

In the step S18, if the communication platform confirms that the control application and login Account ID/password of the controller are legitimacy, then the communication platform allows the controller to log in, followed by performing step S19.

In the step S19, the controller that logs in to the communication platform searches related network devices from the communication platform by the login Account ID and APP ID of the network device, followed by performing step S20.

In the step S20, the communication platform replies the controller with the IP connection method of the network device it desires to search according to the login Account ID, APP ID thereof and IP connection method published by the network device, followed by performing step S21.

In the step S21, the controller establishes connection with the network device it desires to search according to the IP connection method replied by the communication platform to perform control process for the network device. For example, if the network device is a network camera, the control process the controller having device administrator identity executes may include: performing notification setting, such as image event notification, for the network camera, setting geographic information, such as longitude and latitude, of the network camera, or allowing control and access to the Account ID of the network camera. Additionally, the network camera that is set may store the content set by the device administrator. In addition, the setting the geographic information about the longitude and latitude of the network device may also be performed in the above step S12, that is, the controller having device administrator identity sets the geographic information of the longitude and latitude of the connected network device. Correspondingly, in the above step S15, the network device that logs in to the communication platform successfully may not only publish the login Account ID thereof, APP ID and IP connection method, but also publish the geographic information of the longitude and latitude thereof for the controller that logs in to the communication platform to search the network device to be searched according to the geographic information.

Besides, in addition, in the step that the controller sets parameters for the network device that the controller connects to, the controller may further set, for the network device, the APP Resource thereof. For example, if the network device the user of the controller intends to configure is a network camera, and multiple such network cameras are arranged in doors, elevators, ladder spaces on partial important floors etc. in a community building, the user may specify to use the same login Account ID/password for multiple such network cameras, and set different APP Resources. For example, the APP Resource of a certain network camera is set as door, that of another certain network camera is set as ladder etc. Therefore, the controller may control or monitor multiple network devices with only one single login Account ID, and select network devices to be controlled according to different APP Resources. Thus, the communication platform creates identification information of the network device by the login Account ID of the network device, APP ID thereof, APP Resource thereof and IP connection method thereof.

Additionally, it should be noted that, in the above step S11, after the controller logs in to the communication platform successfully, the controller also performs the task as step S15, that is, the controller publishes the login Account ID, APP ID thereof and IP connection method of the controller, and also performs the task similar to the above step S16, that is, the communication platform records the login Account ID, APP ID thereof and IP connection method, thereby, to record identification information of the controller, to provide for the subsequent network device that logs in to the communication platform successfully to search the IP connection method of the controller to be searched according to the login Account ID and APP ID of the controller and connect with the controller and performs mutual interaction through respective applications.

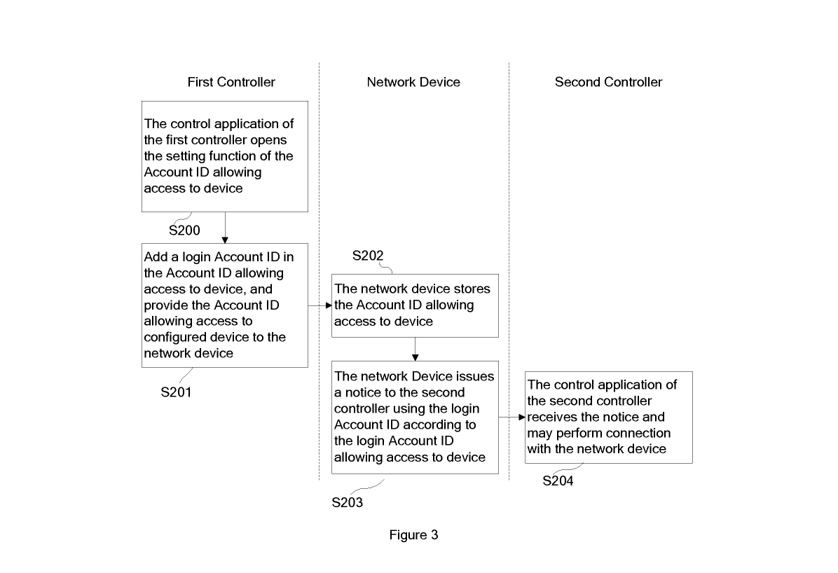

Next, as shown in FIG. 3, it is a method flow chart showing a setting method for Account ID access permissions according to the invention. It should be noted that, all controllers desiring to connect the network device by the communication platform should install and execute the aforementioned control application, and should have performed registration procedure of login Account ID for the communication platform in advance, such that the communication platform records, for the controller that registers successfully, at least registration message, including login Account ID and password thereof, for the communication platform to perform determination of registration legality. In the example, two controllers are described as an example, but the number is not limited thereto, more controllers are possible. Here, it is divided into a first controller and a second controller. Also, here, the user of the first controller is assumed the owner of the network device to be set Account ID access permissions, or an administrator having management authority of the network device, while the user of the second controller is set as an user having the network device authority Account ID.

At first, step S200 is performed, it should be noted that, the step S200 may continue the step S21 in above FIG. 2, that is the owner of the network device, or the administrator having the network device management authority performs control process for the network device through the controller under use. More specifically, after the control application of the first controller connects with the network device to be set Account ID access permissions through the communication platform, the control application opens the setting function of the Account ID allowing access to device for setting the Account ID allowing to access to the network device, followed by performing step S201.

In the step S201, the user of the first controller utilizes the setting function of the Account ID allowing access to device in the control application to add a login Account ID allowing access to network device, provides the added login Account ID allowing access to network device to the network device connected therewith, followed by performing the step S202.

In the step S202, the network device stores the login Account ID allowing access to device, followed by performing the step S203.

In the step S203, the function application of the network device utilizes the login Account ID allowing access to device and the APP ID corresponding to the application capable of interacting with the function application of the network device corresponding to the login Account ID as a search condition to search the control identification information of the second controller using the login Account ID to log in on the communication platform, the control identification information includes “login Account ID, APP ID thereof and IP connection thereof”. Next, the network device issues an access notice to the second controller according to the IP connection method of the identification information of the controller, followed by performing step S204. More specifically, because the communication platform records considerable unit identification information, for the network device to find out the IP connection of the controller it desires to connect quickly and accurately, in the above search condition, not only the login Account ID of the controller to be notified by the network device should be compliant, but also the APP ID (that is, the control application identifier of the controller) corresponding to the application capable of interacting with the function application of the network device should be found out, finally, the control identification information in compliance with the search condition and including “login Account ID, APP ID thereof and IP connection method thereof” may be found out, thereby, the notice may be sent to the second controller according to the IP connection method that is found out. Therefore, it will not occur that, for example, what the network camera should connect is a second controller with camera application installed and executed thereon, but actually a second controller with print application installed and executed thereon is connected. In the step S204, the control application of the second controller receives the access notice and may perform connection with the network device.

From FIG. 3, the owner of the network device or the administrator having management authority may utilize the setting method of Account ID access permissions according to the invention to perform setting of access permissions for the network device quickly and conveniently. On the other hand, the controller set as having the network device authority may connect with the network device quickly and easily.

As for the above step S200, the setting method of the control application of the first controller for the Account allowing access to the network device is based on the form of an access white list. Besides, an access black list may also be set. Briefly, only the access white list is described as an example. Also, to clarify the notification method after access Account ID setting in the setting method of Account ID access permissions according to the invention, one more embodiment is described. Wherein, after the controller serving as the device administrator adds one login Account ID allowing use of the network device for the access white list, the controller serving as the device administrator or the network device that is set issues an access notice message to the controller using the added login Account ID to, thereby, notify the user of the controller of the login Account ID added in the access white list may perform access to the network device.

More specifically, a prompt window will be popped up on the controller of the login Account ID added in the access white list to notify the user of the login Account ID. With the notification event, the user of the login Account added in the access white list recognizes accessible network devices thereof. For example, Mr. Peng is a device administrator of a network printer. Mr. Peng adds Miss Lin's Account ID (that is, the login Account ID that logs in to the communication platform) in the access white list of the network printer through his mobile (the controller with the control application installed and executed thereon, the same as the aforementioned first controller). The mobile or the network printer will issues immediately a notice to the controller (that same as the aforementioned second controller) that logs in to the communication platform using Miss Lin's Account ID. A notification message will be popped up on the controller used by Miss Lin to notify Miss Lin that she can use a certain network printer. Miss Lin taps the notification message to connect the controller she uses with the network printer, or the controller uses by Miss Lin stores the login Account ID of the network printer. In addition, the method that a notification message will popped up on the controller used by Miss Lin is that: the communication platform searches and acquires the IP connection method corresponding to Miss Lin's Account ID allowing access to the network printer, to issue a notice message to the controller using Miss Lin's Account ID according to the IP connection method. As for a conventional setting notice, the example is that: Mr. Peng notifies Miss Lin via call or email, Miss Lin enters the Account ID of the network printer manually by the controller she uses, therefore, compared to the above method, the setting method of Account ID access permissions according to the invention simplifies conventional setting with problems of time and power consumption.

Moreover, the aforementioned Account ID is an Account ID used to log in to the communication platform, while the login Account ID may also be a mail Account ID of current email address. As the aforementioned access black list or access white list is set in such situation, the control application of the controller provides on setting of “performing registrant identity confirmation for the Account ID having a mail box host name”, that is, whether or not to provide access function depends on function variable name entered behind the symbol @. For example, @gmail.com or @hotmail.com is function variable name, which indicates that all login Account IDs under the function variable name are allowed or not allowed to access the network camera, that is, the control application of the controller has the function to identify Account ID mail box host name. Besides, in addition, if the mail Account ID of existing email address is used to register one new login Account ID to the communication platform, the communication platform will issues a confirmation letter with the mail Account ID to the email address to perform address confirmation. If the user of the email address receives the confirmation letter and tap confirmation, then, the communication platform recognizes that this login Account ID is confirmed, and may, thereby, be confirmation that the registrant owns the email address.

More specifically, as a login Account ID having a certain mail box host name is for white list configuration, the network device will perform check for the login Account ID having the mail box host name. Only the login Account ID with above address confirmation may use the network device. The intension is to prevent from theft of host name. For example, the network device may be used with the mail box host name @ibm.com as the login Account ID. Thus, if an user registers a new Account ID xxx@ibm.com (any name without registration is available), then the network device is connected, the network device will check whether or not the Account ID xxx@ibm.com has passed mail confirmation. If the confirmation is not passed, the network device will register the use of the login Account ID.

From above, the login Account ID having the mail box host name has to pass the confirmation of the communication platform before being allowed to use the network device. The above confirmation procedure of the communication platform is for improving the security as the login having mail box host name serves as access white list.

Further, as the controller having device administrator identity sets access white list for the network device, the control application of the controller further provides an option setting of “Allowing Use in Local Area Network”, any controller in the local area network capable of connecting to the local area network, for example, networks in exhibit, company restaurant, or home, may search and connect to the network device (wherein, the search may be performed through communication platform, or by the controller provided with information from the network device). If the network device discovers that the controller connects to the network device directly through the local area network, the network device will allow the controller to use without being constrained by the allowance access white list of the network device. Thus, it is convenient for none specific users to use the network device. For example, multiple network cameras in an exhibit login the communication platform respectively and have “Allowing Use in Local Area Network” set, therefore, any person in the exhibit capable of making the controller to connect to the local area network of the exhibit, in spite of whether or not the communication platform is logged in, as long as the “Searching Local Area Network Device” command is executed (for example, by pressing one specific button on the controller), all network cameras in the local area network of the exhibit may be found out automatically, because these network cameras have “Allowing Use in Local Area Network” configured, the controller may use these network cameras immediately, in spite of whether or not the access white list is configured, or whether or not a certain login Account ID is allowed to use. Of course, as the user leaves the exhibit, because the local area network of the exhibit cannot be connected, the network cameras in the exhibit might not be seen, unless these network cameras have the login Account ID of the controller in the access white list.

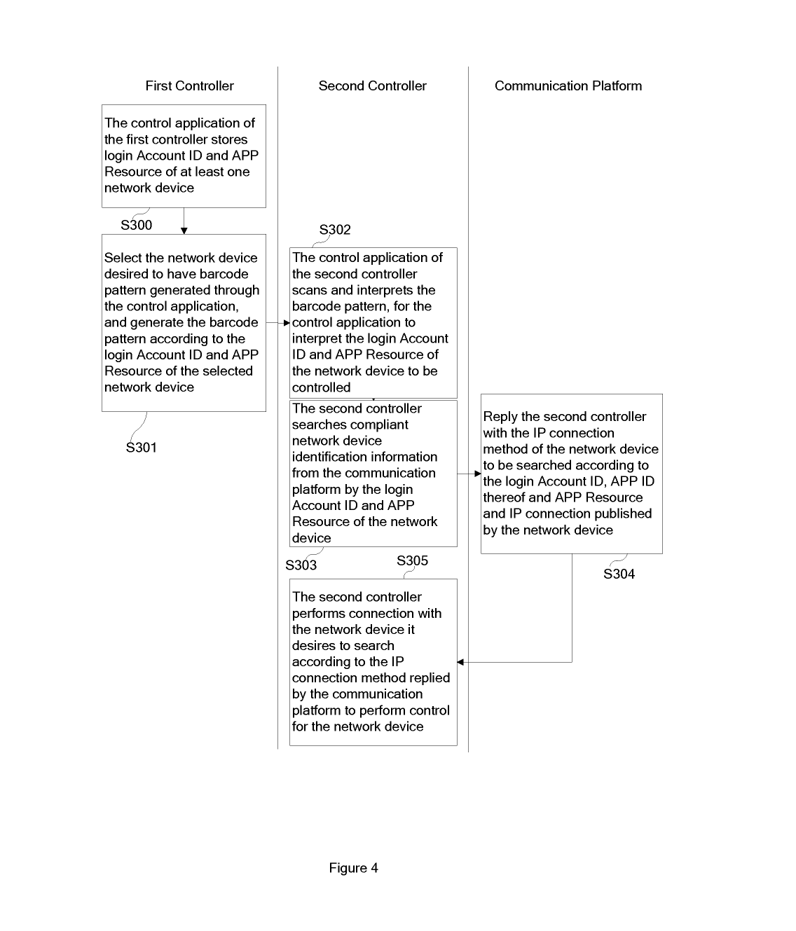

From above, with the above communication platform and the mutual interaction of the applications installed and executed on the controller and the network device respectively, the controller connects with the network device through the communication platform to perform control setting for the network device. The method is relatively convenient compared to existing setting method. Besides, as shown in FIG. 4, it is a method flow chart for quick connection between the second controller and the network device by the barcode pattern performed by the first controller as illustrated in FIG. 3. It should be noted in advance that, the first controller records the login Account IDs and/or APP Resources of one or more network devices ever used. For the controller to perform connection with the network device more quickly, step S300 is performed at first. The control application of the first controller stores login Account IDs and APP Resources of one or more network devices, followed by performing step S301. In addition, the barcode pattern generated by the first controller is not limited to the login Account ID and APP Resource, but may only include the login Account ID.

It should be emphasized particularly that, any controller will remember login Account IDs and/or APP Resource of all controllable network devices, and login Account IDs and/or App Resources of network devices ever connected, or the user of the controller may specify login Account IDs and/or APP Resources of network devices to be remembered in the “My Favorite” list in the control application of the controller. In the step S301, the first controller generates and displays corresponding barcode patter with the login Account ID and APP Resource of a certain network device selected by the user through the control application, followed by performing step S302.

In the step S302, the control application of the second controller scans the barcode pattern displayed on the first controller, for the control application of the second controller to interpret the login Account ID and the APP Resource of the network device to be connected, followed by performing step S303.

In the step S303, the second controller searches matching network device identification information from the communication platform by the login Account ID and APP Resource of the network device, followed by performing step S304.

In the step S304, the communication platform replies the second controller with the IP connection method of the network to be searched according to the login Account ID, APP ID thereof, APP Resource and IP connection method issued by the network device, followed by performing step S305.

In the step S305, the second controller establishes connection with the network device to be searched to perform control for the network device according to the IP connection method replied by the communication platform.

In addition, the above first controller under the performing step S300 and step S301 may operate without logging in to the communication platform, and the above second controller underperforming step S302 may operate without logging in to the communication platform. In other words, the controller may generate or scan the barcode pattern in an off-line status without connecting with the network device. Of course, in the off-line status, the second controller may only store the Account ID acquired from scanning the barcode pattern for future use.

Therefore, from FIG. 4, in the method for quick connection of another controller with the network device with the barcode pattern by the controller is that the controller records login Account IDs and/or APP Resources of one or more network devices thereon, the user of the controller may tap one physical or virtual key for the control application to generate the barcode pattern with a certain selected login Account ID and/or APP Resource for the user of another controller to scan, for example, by pressing a physical or virtual key on said another controller, for said another controller to connect with the network device directly without the need to enter a series of login messages manually, such that the input procedure is simplified significantly.

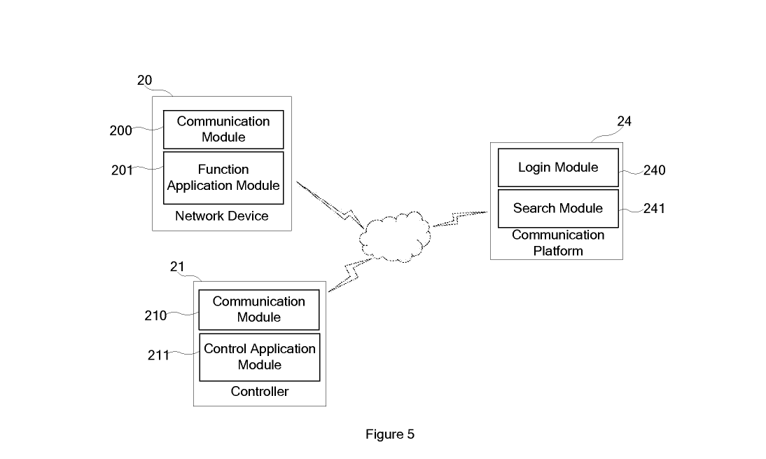

As shown in FIG. 5, which is a basic architecture block diagram showing a controller, communication platform and network device that implement the setting method of Account access permission according to the invention, the invention further provides a controller for the other side controller to connect quickly with a network device so that the setting method for Account access permission illustrated in above FIG. 3 is implemented. A network device 20 at least includes a communication module 200 and a function application module 201. A controller 21 of the invention at least includes a communication module 210 and a control application module 211. The communication platform 24 includes a login module 240 and a search module 241. It should be noted that, to simplify drawing and description, only functional modules related to major features of the invention is stated, other functional modules, for example power module etc., is not described.

The communication module 200 of the network device 20 is used to connect with the communication module 210 of the controller 21, and the communication module 200 and the communication module 210 support connection of wired function or wireless function, for the network device 20 that cannot connect to network to connect with the controller 21 in advance, such that setting parameters of the controller 21 may be received as stated in the step S13 illustrated in FIG. 2 to connect with the communication platform 24 with network method and become a service unit of the communication platform 24.

The login module 240 of the communication platform 34 creates control identification information for the controller 21, including login Account ID thereof, APP ID of the control application module 211 thereof and IP connection method thereof, and also records APP ID (application identifier) of the function application module 201 of the network device 20, after the network device 20 becomes a service unit, identification information of the network device 20 will be recorded on the communication platform 24, including APP ID thereof and IP connection method thereof. As stated above, depending on different application requirements, identification information of the network device 20 will be recorded on the communication platform 24, including login Account ID, APP ID, APP Resource, geographic information and IP connection method thereof.

Besides, for all hardware units that login to the communication platform 24 in compliance with authorization qualification to improve network security of communication platform, the login module 240 may also record identifiers of authorized controllers and/or network devices in advance, such that the controllers and/or network devices are allowed for successful login only after it is confirmed that the identifiers of the controllers and/or network devices have been authorized. The above identifiers may be hardware identifiers or product serial numbers. All identifiers capable of identifying uniqueness of the network devices and/or controllers are applicable.

After the network device 20 becomes a service unit of the communication platform 24, the search module 241 of the communication platform 24 searches connection method of the network device 20 using the login Account ID for login according to the login Account ID/APP Resource entered by the controller 21, and provides the IP connection method that is found out to the controller 21, for the controller 21 to perform connection with the network device 20 to be controlled according to the IP connection method, and perform control for the network device 20.

From above, beside the function of setting the network device 20 that cannot connection to network to become a service unit of the communication platform 24 and performing control process, such as access to the login Account ID of the network device, for the network device 20 that logs in to the communication platform 24, the control application module 211 of the controller 21 further provides functions of generating barcode pattern, scanning barcode pattern and searching network device on a map. In detail, the above function of access to Account ID of the network device indicates the setting of “access to login Account ID of black list or white list”, the setting of “confirming registrant identity for Account ID having mail box host name”, and the setting of “Allowance Use in Local Area Network”, for the authority setting of access Account ID to be more flexible with improved access security, besides, the login Account ID that is set to have access network device authority to connect with the network device more quickly and conveniently. The above function of generating barcode pattern indicates generation of barcode pattern with output or storage for login Account ID and/or APP Resource recorded by the controller for one or more network devices to log in to the communication platform, thereby, for other controllers to be capable of scanning the barcode pattern, and for said other controllers to connect with network devices corresponding to the barcode pattern quickly and conveniently. The above output barcode pattern is, for example, displayed on screen of the controller, printed out, uploaded to cloud, sent to an external storage unit, or stored in local storage unit etc. The above function of scanning barcode pattern is to scan directly the barcode pattern that has been generated, such that after the communication platform is logged in, the network device to be connected is found out according to the login Account ID and/or APP Resource of the network device interpreted via scan. The above function of searching network device on the map is that after the controller 21 logs in to the communication platform, it may display on screen of controller 21 the map information that publishes the geographic information of the network device, for the user of the controller 21 to select directly on the map information the network device to be controlled.

From above, the setting method of Account ID access permissions and controller according to the invention is to utilize scanning barcode pattern to replace convention code as input of login Account ID, and may generate the barcode pattern corresponding to the login Account ID and/or APP Resource used by the controller having device administrator (or device owner) identity to log in the network device under management to the communication platform, or, any controller may generate corresponding barcode pattern from login Account ID and/or APP Resource used to log in network device, which has been connected or recorded, to the communication platform, the generated barcode pattern may be provided for another controller, which has connection requirement, to scan, the method is more convenient compared to existing connection method. Additionally, the controller having device administrator identity may further set access Account ID of network device to be access black list, access white list, and the setting of “performing registrant identity confirmation for Account ID having mail box host name”, further provides the setting of “Allowance Use in Local Area Network”, such that the setting flexibility of network device on access permission is improved significantly.

What is claimed is:

1. A setting method for Account ID access permissions, including establishing connection between a controller and a network device through a communication platform, which records control identification information and network device identification information respectively for the controller and the network device that has logged in to the communication platform, and the control identification information includes a login Account ID used to log in to the communication platform, an APP ID and an IP connection method of a control application installed and executed on the controller; the network device identification information includes a login Account ID used to log in to the communication platform, an APP ID and an IP connection method of a function application installed and executed on the network device; the setting method for Account ID access permissions includes the following procedures: after the control application of the controller connects, through the communication platform, with the network device whose Account ID access permissions are to be set, a setting function of the Account ID access permissions is opened in the control application with setting result entered, and the setting result to the network device connected therewith; and
the function application of the network device stores the setup result and opens or restrict access to the network device according to the setting result.

2. The setting method for Account ID access permissions of claim 1, wherein, the login Account ID of the controller is an Account ID having the network device administrator identity, and the setting function of the Account ID access permissions opened by the control application of the controller includes: setting of whether or not to grant access to the Account ID of the network device, or setting of whether or not to allow use of said network device in a local area network.

3. The setting method for Account ID access permissions of claim 2, wherein, the controller or the configured network device searches on the communication platform and acquires controller identification information, and subsequently, according to a located IP connection method in the controller identification information, a notice is issued to the controller, which uses the Account ID with granted access to the network device and thereby logs in to the communication platform, wherein, the controller identification information at least includes the Account ID which grants access to the network device, and the APP ID corresponding to the Account ID is an APP ID corresponding to an application capable of interacting with the function application of the network device.

4. The setting method for Account ID access permissions of claim 3, wherein, after the controller receives the notice, the control application thereof performs direct connection with the network device allowed to be accessed.

5. The setting method for Account ID access permissions of claim 3, wherein, the control application of the controller further has a setting function of registrant identity confirmation for Account ID having a mail box host name, such that when the login Account ID used to log in to the communication platform is a mail Account ID of an email address, the mail box host name of the mail account ID identifies if the mail Account ID is granted access to the network device.

6. The setting method for Account ID access permissions of claim 5, wherein, as the communication platform receives that a login Account ID is to be registered and applied with the Account ID in the form of email address, the communication platform issues a confirmation letter to the email address by the mail Account ID, for an user of the email address to open the confirmation letter, tap confirmation and subsequently connect the communication platform so that the login Account ID becomes a confirmed Account ID.

7. The setting method for Account ID access permissions of claim 1, further including the following procedures: selecting, by the control application of the controller, at least one login Account ID to perform barcode pattern generation process from recorded login Account IDs of the at least one network device, to generate the barcode pattern corresponding to at least one selected login Account ID; scanning, by the control application of another controller, the generated barcode pattern for the control application of said another controller to interpret the login Account ID of the network device to be connected;
searching, by the control application of said another controller, corresponding identification information of the network device on the communication platform with the interpreted login Account ID of the network device;
replying, by the communication platform, said another controller with the IP connection method of the network device to be connected according to the identification information of the located network device; and
establishing, by said another controller, connection with the network device to be connected according to the IP connection method replied by the communication platform.

8. The setting method for Account ID access permissions of claim 7, wherein, the network device identification information stored by the communication platform further includes APP Resource of the network device, and the message on which the control application of the controller performs barcode pattern generation process further includes an APP Resource corresponding to at least one login Account ID.

9. The setting method for Account ID access permissions of claim 2, wherein, as the login Account ID used by the controller is the same as the login Account ID used by the configured network device, the function application of the network device recognizes that the controller using the same login Account ID to log in to the communication platform has administrator identity to manage the network device, then the controller is allowed to perform the aforementioned setting function of Account ID access permissions for the network device.

10. A controller, which is used to log in to a communication platform to connect with at least one network device that has logged in to the communication platform for the controller to perform interaction process with said at least one network device, said network device having a function application module, said communication platform storing network device identification information, inclusive of a login Account ID thereof, an APP ID of the function application module and an IP connection method thereof, for the network device that has logged in successfully, the controller including:
a communication module, used to connect with the network device and/or communication platform; and
a control application module, used to output, through the communication platform, login Account ID/password used to log in to the communication platform, for the communication platform to record controller identification information for the controller that logs in successfully, the controller identification information including login Account ID thereof, APP ID of control application installed and executed thereon, and IP connection method, and performing setting function of Account ID access permissions for the network device after connecting with the network device, and for the function application module of the network device to store a setting result, to grant or restrict access to the network device according to the setting result.

11. The controller of claim 10, wherein the setting function of the Account ID access permissions performed by the control application module of the controller for the network device includes: setting of whether or not to grant access to the Account ID of the network device, or setting of whether or not to allow use of the network device in a local area network.

12. The controller of claim 11, wherein, controller identification information is searched and acquired on the communication platform by the controller or by the configured network device, and subsequently, according to a located IP connection method in the controller identification information, a notice is issued to the controller which uses the Account ID which grants access to the network device and logs in to the communication platform, wherein, the controller identification information at least includes the Account ID which grants access to the network device, while the APP ID corresponding to the Account ID is an APP ID corresponding to an application capable of interacting with the function application of the network device.

13. The controller of claim 12, wherein, after the controller receives the notice, the control application thereof performs direct connection with the network device allowed to be accessed.

14. The controller of claim 11, wherein, the control application module of the controller further provides a setting function which confirms registrant identity for the Account ID with a mail box host name, such that as the login Account ID used to log in to the communication platform is an Account ID in the form of email address, the mail box host name of the Account ID is used to identify if the Account ID is granted access to the network device.

15. The controller of claim 14, wherein, when the communication platform receives a login Account ID that is to be registered and applied with email address data format, the communication platform issues a confirmation letter to the email address for an user of the address to tap confirmation, and the communication platform is connected after confirmation process for the login Account ID to become a confirmed Account ID.

16. The controller of claim 10, wherein, the control application module further performs recording for the login Account ID used by the network device that has been performed with control process, and lists recorded login Account IDs of the network device for selection, and a selected login Account ID will have a corresponding barcode pattern generated.

17. The controller of claim 16, wherein, the control application module further has a function of scanning barcode pattern, to interpret a login Account ID of a network device represented by the barcode pattern, and to search network device identification information in compliance with the login Account ID on the communication platform, and thereby to acquire an IP connection method of the network device based on the located network device identification information, and to establish connection.

18. The controller of claim 16, wherein, the network device identification information stored by the communication platform further includes APP Resource of the network device, and the message on which the control application module of the controller is to perform barcode pattern generation process further includes an APP Resource corresponding to said at least one login Account ID.

19. The controller of claim 11, wherein, as the login Account ID used by the controller is the same as the login Account ID of the network device, the function application module of the network device recognizes that the controller using the same login Account ID thereof to log in to the communication platform has administrator identity to manage the network device, then the controller is allowed to perform the aforementioned setting function of Account ID access permissions for the network device.
